(19) United States
(12) Patent Application Publication
(10) Pub. No.: US 2013/0157762 A1
(43) Pub. Date: Jun. 20, 2013

(54) GAME DEVICE, METHOD OF CONTROLLING A GAME DEVICE, AND INFORMATION STORAGE MEDIUM

(71) Applicant: Konami Digital Entertaiment Co., Ltd., Tokyo (JP)

(72) Inventors: Takashi YAMAGUCHI, Yokohama-shi (JP); Takeshi YAMAGUCHI, Tama-shi (JP); Takaki INAZUMI, Sagamihara-shi (JP); Yasushi KAWASAKI, Oiso-machi (JP)

(73) Assignee: KONAMI DIGITAL ENTERTAINMENT CO., LTD., Tokyo (JP)

(21) Appl. No.: 13/711,065

(22) Filed: Dec. 11, 2012

(30) Foreign Application Priority Data
Dec. 14, 2011 (JP) 2011-273085

(51) Int. Cl. A63F 13/10

(52) U.S. Cl. CPC A63F 13/10
USPC 463/31; 463/43

(57) ABSTRACT

A current value guide unit of a game device shows a user a current value of one game parameter indicating a current state of an operation subject. An action control unit causes the operation subject to perform an action in response to an operation performed by the user. A game parameter changing unit causes the one game parameter to change in a case where the operation subject moves, a case where the operation subject attacks an enemy, and a case where the operation subject receives damage due to an attack from the enemy. A determination unit determines whether or not the current value of the one game parameter is within a predetermined range. An inhibition unit inhibits the operation subject from performing an action when it is determined that the current value of the one game parameter is within the predetermined range.

### CROSS-REFERENCE TO RELATED APPLICATION

The present application claims priority from Japanese application JP 2011-273085 filed on Dec. 14, 2011, the content of which is hereby incorporated by reference into this application.

### BACKGROUND OF THE INVENTION

1. Field of the Invention

The present invention relates to a game device, a method of controlling a game device, and an information storage medium.

2. Description of the Related Art

Up to now, there has been known a game device for executing a game configured so that an operation subject of a user moves within a virtual space to attack an enemy. Japanese Patent Application Laid-open No. 2006-187381 discloses a game device for executing the above-mentioned game further configured so that a hit point is reduced when the operation subject receives damage due to an attack from the enemy and the game is over when the hit point becomes zero.

### SUMMARY OF THE INVENTION

However, with the technology disclosed in Japanese Patent Application Laid-open No. 2006-187381, even if the operation subject performs a wasteful action (for example, repeats a wasteful movement or a useless attack), the user can eventually complete the game by only having to destroy the enemy while keeping the hit point from being zero. In this manner, the game played on the conventional game device is poor in strategic property because the user can complete the game without having to develop such a strategy as to prevent the operation subject from performing a wasteful action.

The present invention has been made in view of the above-mentioned problem, and an object thereof is to provide a game device, a method of controlling a game device, and an information storage medium which can enhance a strategic property of a game.

In order to solve the above-mentioned problem, according to an exemplary embodiment of the present invention, there is provided a game device for executing a game configured so that an operation subject of a user moves within a virtual space to attack an enemy, the game device including: means for acquiring one game parameter indicating a current state of the operation subject from means for storing the one game parameter; current value guide means for showing the user a current value of the one game parameter; action control means for causing the operation subject to perform an action in response to an operation performed by the user; game parameter changing means for changing the one game parameter in a case where the operation subject moves, a case where the operation subject attacks the enemy, and a case where the operation subject receives damage due to an attack from the enemy; determination means for determining whether or not the current value of the one game parameter is within a predetermined range; and inhibition means for inhibiting the operation subject from performing an action in a case where it is determined that the current value of the one game parameter is within the predetermined range.

According to the exemplary embodiment of the present invention, there is also provided a method of controlling a game device for executing a game configured so that an operation subject of a user moves within a virtual space to attack an enemy, the method including: a step of acquiring one game parameter indicating a current state of the operation subject from means for storing the one game parameter; a current value guide step of showing the user a current value of the one game parameter; an action control step of causing the operation subject to perform an action in response to an operation performed by the user; a game parameter changing step of changing the one game parameter in a case where the operation subject moves, a case where the operation subject attacks the enemy, and a case where the operation subject receives damage due to an attack from the enemy; a determination step of determining whether or not the current value of the one game parameter is within a predetermined range; and an inhibition step of inhibiting the operation subject from performing an action in a case where it is determined that the current value of the one game parameter is within the predetermined range.

According to the exemplary embodiment of the present invention, there is also provided a program for causing a computer to function as a game device for executing a game configured so that an operation subject of a user moves within a virtual space to attack an enemy, the game device including: means for acquiring one game parameter indicating a current state of the operation subject from means for storing the one game parameter; current value guide means for showing the user a current value of the one game parameter; action control means for causing the operation subject to perform an action in response to an operation performed by the user; game parameter changing means for changing the one game parameter in a case where the operation subject moves, a case where the operation subject attacks the enemy, and a case where the operation subject receives damage due to an attack from the enemy; determination means for determining whether or not the current value of the one game parameter is within a predetermined range; and inhibition means for inhibiting the operation subject from performing an action in a case where it is determined that the current value of the one game parameter is within the predetermined range.

According to the exemplary embodiment of the present invention, there is also provided a non-transitory computer readable information storage medium having recorded thereon the above-mentioned program.

According to the present invention, it is possible to enhance the strategic property of a game.

Further, according to the exemplary embodiment of the present invention, the game device further includes: means for causing display means to display a virtual space image showing how the virtual space is viewed from a virtual viewpoint; means for changing at least one of a position and a sight line direction of the virtual viewpoint in response to the operation performed by the user; means for determining whether or not the operation subject is being displayed on the display means; and means for changing the one game parameter in a case where it is determined that the operation subject is not being displayed on the display means.

Further, according to the exemplary embodiment of the present invention, the game device further includes: means for causing display means to display a virtual space image showing how the virtual space is viewed from a virtual viewpoint; means for changing at least one of a position and a sight line direction of the virtual viewpoint in response to the operation performed by the user; and means for determining whether or not the operation subject is being displayed on the display means, in which the game parameter changing means includes means for one of increasing and decreasing a change amount of the one game parameter in a case where the operation subject is being displayed on the display means compared to a case where the operation subject is not being displayed on the display means.

Further, according to the exemplary embodiment of the present invention, the game device further includes: means for causing display means to display a virtual space image showing how the virtual space is viewed from a virtual viewpoint; means for changing at least one of a position and a sight line direction of the virtual viewpoint in response to the operation performed by the user; means for acquiring change amount information relating to a change amount of the one game parameter from means for storing a condition and the change amount information in association with each other, the condition relating to a positional relationship between the position of the virtual viewpoint and one of a position of the operation subject and a reference point which is set in the virtual space; and means for determining whether or not the condition is satisfied by a current positional relationship between the position of the virtual viewpoint and the one of the position of the operation subject and the reference point, in which the game parameter changing means changes the one game parameter based on the change amount information associated with the condition satisfied by the current positional relationship between the position of the virtual viewpoint and the one of the position of the operation subject and the reference point.

Further, according to the exemplary embodiment of the present invention, the game device further includes: photographing means for photographing a real space in which a detection subject is disposed, which has a photographing range that changes in response to the operation performed by the user; means for causing display means to display an image obtained by synthesizing a real space image showing the real space and a virtual space image showing how the virtual space is viewed from a virtual viewpoint; means for changing at least one of a position and a sight line direction of the virtual viewpoint based on a position, a size, and an orientation of the detection subject within the real space image; means for determining, based on the real space image, whether or not a current positional relationship between the detection subject and the photographing means is a given positional relationship; and means for changing the one game parameter in a case where it is determined that the current positional relationship between the detection subject and the photographing means is the given positional relationship.

Further, according to the exemplary embodiment of the present invention, the game device further includes: photographing means for photographing a real space in which a detection subject is disposed, which has a photographing range that changes in response to the operation performed by the user; means for causing display means to display an image obtained by synthesizing a real space image showing the real space and a virtual space image showing how the virtual space is viewed from a virtual viewpoint; means for changing at least one of a position and a sight line direction of the virtual viewpoint based on a position, a size, and an orientation of the detection subject within the real space image; means for acquiring change amount information relating to a change amount of the one game parameter from means for storing a condition and the change amount information in association with each other, the condition relating to a positional relationship between the detection subject and the photographing means; and means for determining, based on the real space image, whether or not the condition is satisfied by a current positional relationship between the detection subject and the photographing means, in which the game parameter changing means changes the one game parameter based on the change amount information associated with the condition satisfied by the current positional relationship between the detection subject and the photographing means.

Further, according to the exemplary embodiment of the present invention, the current value guide means includes: means for showing the user the current value of the one game parameter by causing display means to display a current value gauge indicating the current value of the one game parameter; and means for expanding and contracting, in a case where the one game parameter is changed by the game parameter changing means, the current value gauge depending on the change, and the game device further includes means for displaying an image having substantially the same length as an expansion/contraction length of the current value gauge which is used in the case where the operation subject makes an attack in such a position that an edge part of the image corresponds to an edge part of the current value gauge.

### BRIEF DESCRIPTION OF THE DRAWINGS

In the accompanying drawings:

FIG. 1 is a diagram illustrating a hardware configuration of a game device according to an embodiment of the present invention;

FIG. 2 is a diagram illustrating how a user plays a game that utilizes an augmented reality;

FIG. 3 is a diagram illustrating an example of a virtual space;

FIG. 4 is a diagram illustrating an example of a game screen displayed on a display unit;

FIG. 5 is a functional block diagram illustrating functions implemented by the game device;

FIG. 6 is a diagram for illustrating a method of controlling a virtual camera which is performed by a virtual viewpoint control unit;

FIG. 7 is a diagram illustrating a change amount of an energy parameter which is obtained in a case where a tank moves, a case where the tank makes an attack, and a case where the tank receives damage due to the attack from an enemy;

FIG. 8 is a flowchart illustrating processing executed by the game device which relates to the present invention;

FIG. 9 is a flowchart illustrating the processing executed by the game device which relates to the present invention; and

FIG. 10 is a diagram illustrating association between a positional relationship condition and change amount information.

### DETAILED DESCRIPTION OF THE INVENTION

### 1. Embodiment

Detailed description is hereinafter given of an embodiment of the present invention with reference to the drawings. A game device according to the present invention is implemented by, for example, a consumer game machine (stationary game machine), a portable game machine, a cellular phone (smartphone), a personal digital assistant (PDA), or a personal computer. Herein, description is given of a case where the game device according to the embodiment of the present invention is implemented by a portable game machine.

### 2. Hardware Construction of Game Device

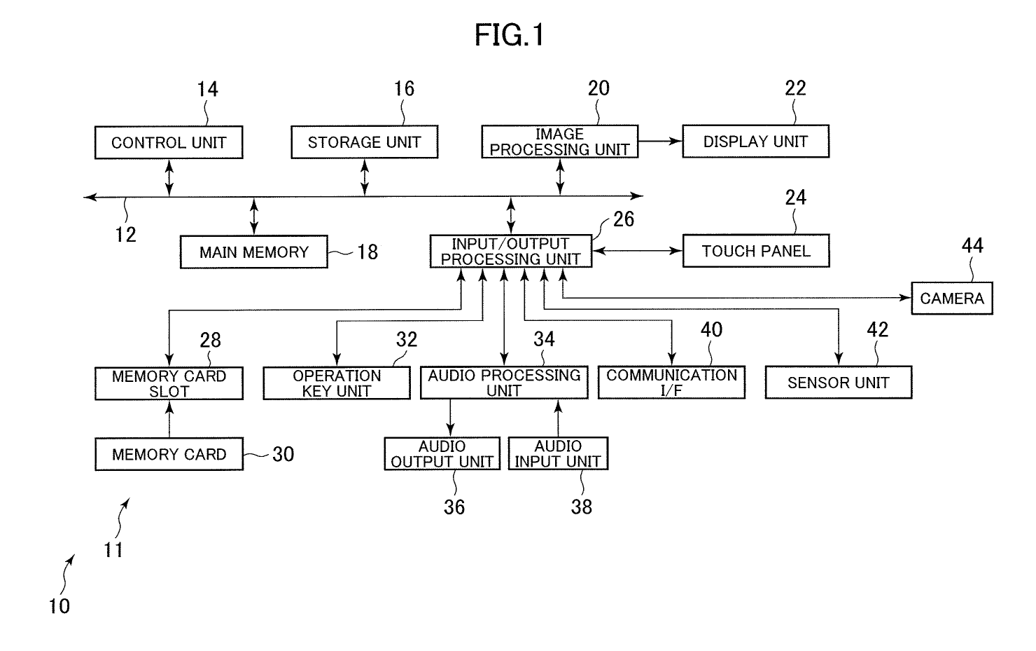

FIG. 1 is a diagram illustrating a hardware configuration of a game device 10 according to the embodiment of the present invention. As illustrated in FIG. 1, the game device 10 includes a portable game machine 11. The portable game machine 11 includes a control unit 14, a storage unit 16, a main memory 18, an image processing unit 20, a display unit 22, a touch panel 24, an input/output processing unit 26, a memory card slot 28, an operation key unit 32, an audio processing unit 34, an audio output unit 36, an audio input unit 38, a communication interface 40, a sensor unit 42, a camera 44, and the like.

The control unit 14 controls the components of the game device 10 based on an operating system which is stored in the storage unit 16, and on a program and various kinds of data which are stored in a memory card 30. Further, the control unit 14 includes a real-time clock, and functions as means for measuring time.

The storage unit 16 includes a non-volatile storage medium such as a flash memory. The storage unit 16 stores an operating system and the like.

The main memory 18 includes, for example, a RAM. A program stored in the storage unit 16 and a program read out of the game memory card 30 via the memory card slot 28 are written into the main memory 18 as the need arises. The main memory 18 is also used as a work memory of the control unit 14.

A bus 12 is used to exchange addresses and various kinds of data between the components of the game device 10. The control unit 14, the storage unit 16, the main memory 18, the image processing unit 20, and the input/output processing unit 26 are connected to one another by the bus 12 in a manner that allows those components to communicate data between one another.

The image processing unit 20 includes a VRAM. The image processing unit 20 renders an image in the VRAM in accordance with an instruction from the control unit 14. The image rendered in the VRAM is displayed on the display unit 22 at a predetermined timing. The display unit 22 is, for example, one or a plurality of known liquid crystal display panels. The touch panel 24 is provided so as to be superimposed on the display unit 22.

The input/output processing unit 26 is an interface by which the control unit 14 exchanges various kinds of data with the touch panel 24, the memory card slot 28, the operation key unit 32, the audio processing unit 34, and the communication interface (I/F) 40.

The memory card slot 28 reads a game program and game data stored in the memory card 30 in accordance with an instruction issued from the control unit 14. The memory card 30 includes, for example, a non-volatile storage medium in which the game data such as save data is stored.

In this embodiment, the description is given of a case where the program and the data stored in the memory card 30 are used to execute a game, but any information storage medium other than the memory card 30 may be used. In addition, the program and the data may be supplied to the game device 10 from a remote site via a communication network such as the Internet.

The operation key unit 32 functions as input means by which the user performs various kinds of operations. The operation key unit 32 includes a cross-shaped button, a slide pad, and various kinds of buttons. The input/output processing unit 26 scans the state of each part of the operation key unit 32 every predetermined cycle (e.g., every 1/60th of a second), and supplies an operation signal representing the scanning result to the control unit 14 via the bus 12. The control unit 14 determines a content of the user's operation based on the operation signal.

The audio processing unit 34 includes a sound buffer. The audio processing unit 34 outputs a music track or audio from the audio output unit 36 based on data stored in the sound buffer.

The audio input unit 38 includes a microphone. The audio input unit 38 detects a user's voice or the like, and inputs a detection signal to the control unit 14 via the input/output processing unit 26. The communication I/F 40 is an interface for connecting the game device 10 to the communication network. The sensor unit 42 includes a gyro sensor for detecting an angular velocity and an acceleration sensor for detecting acceleration.

The camera 44 includes a CMOS camera or a CCD camera, and photographs a real space. In this embodiment, the camera 44 is included inside a casing of the game device 10, and a photographing range thereof changes when the user changes a position or a posture of the camera 44.

### 3. Game Executed by the Game Device

The game device 10 executes a game configured so that an operation subject of the user moves within a virtual space to attack an enemy. Description is given below of a case where a game that utilizes an augmented reality (AR) is executed. In the game that utilizes the augmented reality, a screen obtained by compositing a real world and a virtual world is displayed to thereby provide the user with a world expressed by blending the real world and the virtual world into one.

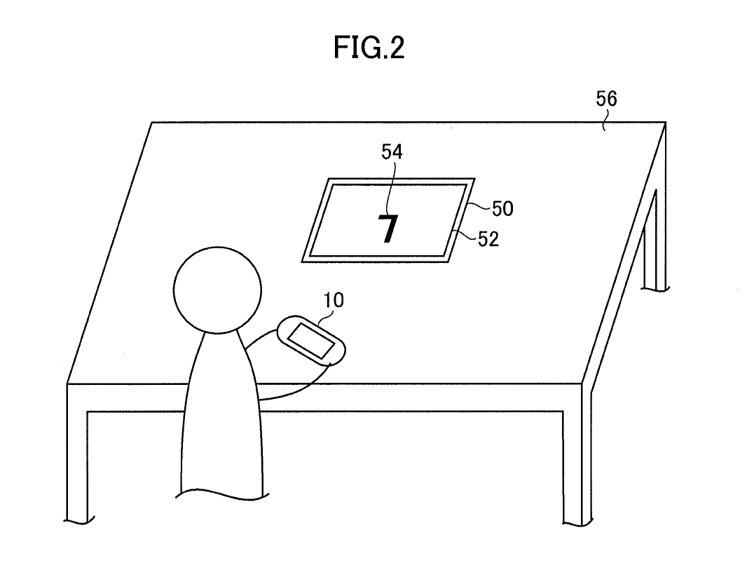

FIG. 2 is a diagram illustrating how the user plays the game that utilizes the augmented reality. As illustrated in FIG. 2, the user plays the game while using the camera 44 of the game device 10 to photograph a marker 50 (detection subject) in which a predetermined pattern 54 is drawn. The marker 50 is a recording medium such as paper or a film. For example, the marker 50 is disposed on a desk 56 in the real space.

In this embodiment, the description is directed to a case where the marker 50 has a frame 52 (for example, rectangular frame) having a predetermined size with the predetermined pattern 54 (for example, bilaterally asymmetrical pattern 54) drawn within the frame 52. In this case, as illustrated in FIG. 2, the description is directed to a case where an “L-shaped” pattern 54 is drawn in the marker 50, but any markers having various patterns used in the augmented reality can be applied.

Data for identifying the pattern 54 drawn in the marker 50 is previously stored in the storage unit 16 or the memory card 30. The game device 10 compares the pattern 54 included in a real space image obtained by the camera 44 photographing the real space with the above-mentioned stored pattern 54 based on a known image comparison algorithm, to thereby identify information relating to a type, a position, and a size of the marker 50 disposed in the real space and an orientation of the pattern 54.

The identified information (for example, type, position, and size of the marker 50 and orientation of the pattern 54) is used for determining where an object disposed in the virtual space is to be displayed, at which size and in which orientation. In other words, the information indicating the type, the position, and the size of the marker 50 and the orientation of the pattern 54 is used for performing alignment between the virtual space and the real space to be displayed on the display unit 22.

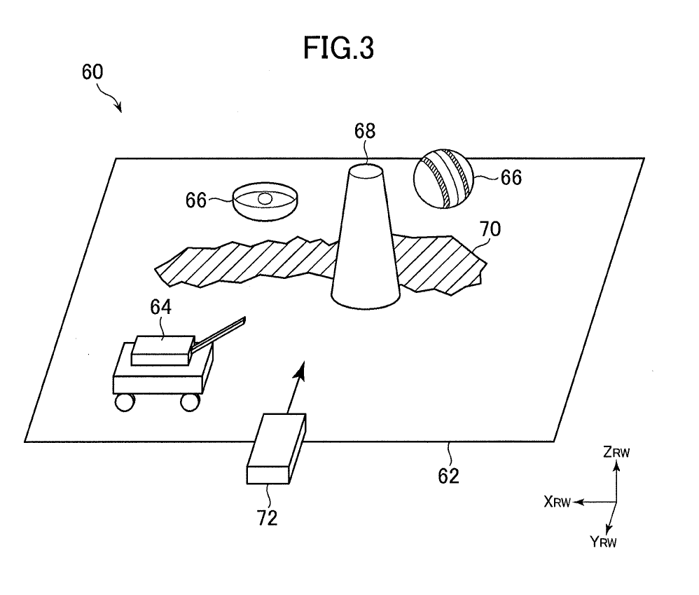

FIG. 3 is a diagram illustrating an example of the virtual space. When a game is started, a game space 60 (virtual three-dimensional space) that imitates a battlefield is generated in the main memory 18. Set in the game space 60 are three axes orthogonal to one another (virtual space coordinate system described later). The position of each of objects disposed in the game space 60 and the position of a virtual camera 72 described later are defined based on three-dimensional coordinates which are set in the game space 60.

As illustrated in FIG. 3, a field 62 that is an object representing the battlefield is disposed in the game space 60. A tank 64 that is an object representing the operation subject of the user, enemies 66 that are objects representing enemies to be attacked by the tank 64, an obstruction 68 that is an object representing an obstruction disposed in the battlefield, and an opening 70 that is an object representing an opening existing in the battlefield are disposed on the field 62.

The tank 64 performs an action in response to the user's operation. When the user performs a direction instruction operation, the tank 64 moves or rotates in a direction indicated by the direction instruction operation. Note that the tank 64 may be configured to become inoperative when the tank 64 falls into the opening 70. Further, for example, when the user performs an attack instruction operation, the tank 64 launches a shell in a predetermined direction to attack the enemy 66 in accordance with the attack instruction operation. When the shell is launched from the tank 64, an object (not shown) representing the shell is generated. The object moves based on a given movement algorithm, and can cause damage to the enemy 66 when colliding with the enemy 66. Note that, the shell launched from the tank 64 may be configured to vanish when the shell collides with the obstruction 68.

On the other hand, the enemy 66 performs an action in response to an operation performed by the computer. For example, when a distance between the tank 64 and the enemy 66 becomes within a predetermined distance, the enemy 66 launches the object (not shown) representing the shell toward the tank 64 to attack the tank 64. When the object collides with the tank 64, the tank 64 receives damage. In this manner, the user aims at causing the tank 64 to destroy the enemy 66 while moving the around tank 64 and avoiding the attack from the enemy 66.

Further, in the game space 60, the virtual camera 72 (viewpoint) is set. A virtual space image showing how the game space 60 is viewed from the virtual camera 72 is generated at predetermined time intervals. For example, the virtual space image showing the objects within a visual field (view volume) of the virtual camera 72 among the objects disposed in the game space 60 is generated. In this embodiment, the game that utilizes the augmented reality is executed, and hence a game screen obtained by compositing the real space image showing the real space with the virtual space image is displayed on the display unit 22.

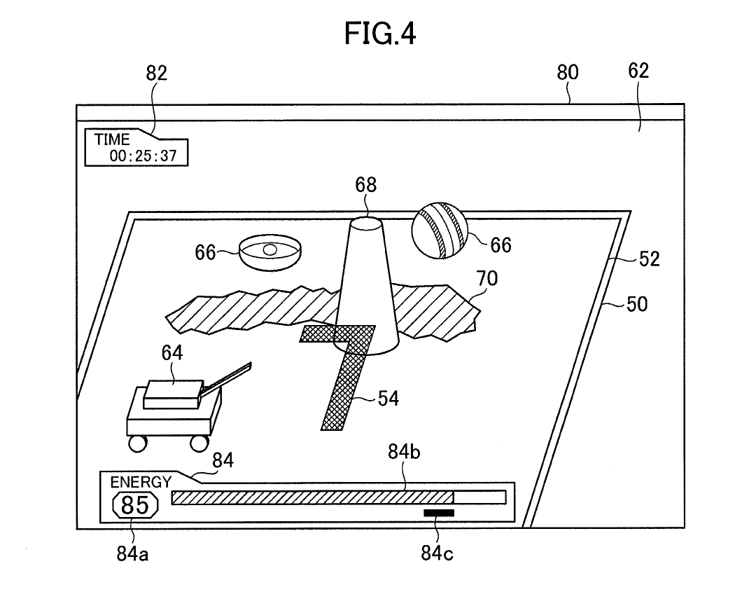

FIG. 4 is a diagram illustrating an example of the game screen displayed on the display unit 22. As illustrated in FIG. 4, the real space image and the virtual space image are composited with each other to be displayed on a game screen 80. For example, in the case where the marker 50 is disposed on the desk 56 in the real space, the virtual camera 72 is controlled so that the field 62 is disposed on the desk 56 within the real space on the game screen 80.

When the photographing range (area) of the camera 44 moves, a photographing range (area) of the virtual camera 72 moves in accordance with the movement. In other words, when the user changes the position, the orientation, or the posture of the game device 10 to change the photographing range of the camera 44, the photographing range of the virtual camera 72 changes in accordance with the change. For example, in the case of the game screen 80 illustrated in FIG. 4, when the user rotates the camera 44 leftward, the virtual camera 72 accordingly rotates leftward to widely display a rear of the tank 64.

Further, as illustrated in FIG. 4, an elapsed time image 82 for indicating an elapsed time since a start of the game and an energy guide image 84 for indicating remaining energy of the tank 64 are displayed on the game screen 80. The elapsed time indicated by the elapsed time image 82 is updated appropriately based on timing performed by the control unit 14.

The energy guide image 84 includes a current value 84a for indicating a value of current energy of the tank 64, a current value gauge 84b corresponding to the current value 84a, and a consumption amount image 84c for indicating a consumption amount of energy to be consumed by the tank 64 when making an attack. In this case, the energy of the tank 64 is reduced not only in the case where the tank 64 makes an attack but also in the case where the tank 64 moves and the case where the tank 64 receives damage due to the attack from the enemy 66.

When the remaining energy of the tank 64 becomes zero, the tank 64 becomes inoperative and the game is over. Therefore, in the game according to the embodiment, the game can be over not only when the tank 64 receives damage from the enemy 66 but also when moving too far on the field 62 or when attacking the enemy 66 too often.

In this manner, the game device 10 according to this embodiment is configured to be able to provide the user with the game that is high in strategic property which is configured so that the tank 64 is caused to destroy the enemy 66 without performing a wasteful action. The above-mentioned technology is hereinafter described in detail.

### 4. Functions Implemented by the Game Device

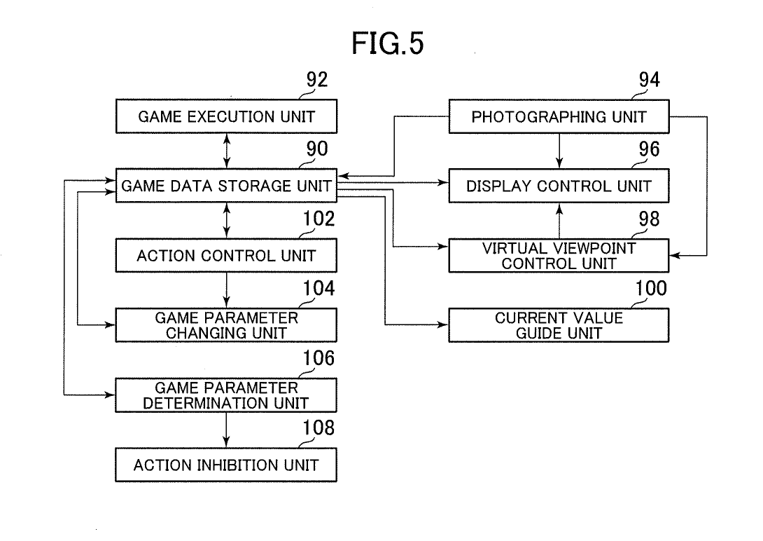

FIG. 5 is a functional block diagram illustrating functions implemented by the game device 10. As illustrated in FIG. 5, the game device 10 includes a game data storage unit 90, a game execution unit 92, a photographing unit 94, a display control unit 96, a virtual viewpoint control unit 98, a current value guide unit 100, an action control unit 102, a game parameter changing unit 104, a game parameter determination unit 106, and an action inhibition unit 108. Those respective functions are implemented by, for example, the control unit 14 executing the program stored in the memory card 30.

### (4-1. Game Data Storage Unit)

The game data storage unit 90 is implemented mainly by the main memory 18 and the memory card 30. The game data storage unit 90 stores various kinds of game data necessary to execute a game. In this case, the game data storage unit 90 stores game situation data indicating a situation of the game being executed and augmented reality data necessary for providing the user with the augmented reality.

### (Game Situation Data)

The game situation data includes, for example, the following data. That is, the game situation data includes: (1) one game parameter (for example, energy parameter indicating the remaining energy of the tank 64) indicating a current state of the operation subject (for example, tank 64); (2) a game parameter indicating a current state of the enemy 66 (such as stamina of the enemy 66); (3) a parameter indicating a specific ability (performance such as attacking power and defensive power) relating to the tank 64 or the enemy 66; (4) data indicating a current situation of the game space 60; and (5) data indicating other situations (such as elapsed time since the start of the game) of the game being executed.

As described above, in this embodiment, only one game parameter indicating the state of the tank 64, that is, the energy parameter, is used, and only the energy parameter is shown to the user. Note that the data indicating the current situation of the game space 60 stores, for example, information relating to the position, the posture, the orientation, and the moving direction of each of the objects disposed in the game space 60 and information relating to the visual field (for example, position and sight line direction) of the virtual camera 72.

### (Augmented Reality Data)

The augmented reality data includes, for example, image data indicating the pattern 54 of the marker 50. The image data is used as a subject to be compared with the marker 50 disposed in the real space (in other words, marker 50 included in the real space image). In other words, the augmented reality data is data for defining the pattern 54 of the marker 50 necessary for the user to utilize the augmented reality.

Note that the control unit 14 functions as means for acquiring the various kinds of data stored in the game data storage unit 90. Further, the control unit 14 functions as means for changing (updating) the various kinds of data stored in the game data storage unit 90. Further, the data stored in the game data storage unit 90 is not limited to the above-mentioned example, and any data that is necessary for the game device 10 to execute the game may be stored.

### (4-2. Game Execution Unit)

The game execution unit 92 is implemented mainly by the control unit 14. The game execution unit 92 executes a game configured so that the operation subject of the user (for example, tank 64) moves within the virtual space (for example, game space 60) to attack the enemy 66. The game execution unit 92 updates the game situation data so as to correspond to progress of the game.

For example, the game execution unit 92 may change the energy parameter when the user performs an instruction operation to use a predetermined item. Further, for example, the game execution unit 92 may change the energy parameter in a case where the tank 64 has not been moved for a fixed time. Further, for example, the game execution unit 92 causes the enemy 66 to perform an action based on a given behavior algorithm. For example, when the distance between the tank 64 and the enemy 66 becomes within the predetermined distance, the enemy 66 is caused to attack the tank 64.

### (4-3. Photographing Unit)

The photographing unit 94 is implemented mainly by the control unit 14 and the camera 44. The photographing unit 94 has the position of the photographing range changed in response to the user's operation, and photographs the real space in which the detection subject (for example, marker 50) is disposed. The photographing range is changed by the user changing the position, the orientation, and the posture of the casing in which the photographing unit 94 is stored. The photographing range of the photographing unit 94 is determined based on the position and the sight line direction of the photographing unit 94 within the real space.

The image data on the real space image generated by the photographing unit 94 photographing the real space is temporarily stored in, for example, the game data storage unit 90. In this case, the real space image is generated at predetermined time intervals (for example, intervals corresponding to a frame rate which is set in the photographing unit 94) by the photographing unit 94 continuously photographing the real space.

### (4-4. Display Control Unit)

The display control unit 96 is implemented mainly by the control unit 14. The display control unit 96 causes display means (for example, display unit 22) to display the virtual space image showing how the virtual space (for example, game space 60) is viewed from a virtual viewpoint (for example, virtual camera 72). In this case, the display control unit 96 displays an image obtained by synthesizing the real space image showing the real space and the virtual space image.

The virtual space image is generated by having vertex coordinates of the object existing within the visual field of the virtual camera 72 converted from the three-dimensional coordinates into two-dimensional coordinates. The time intervals at which the virtual image is generated may be defined based on the time intervals (in other words, frame rate of the photographing unit 94) at which the real space image is generated.

Note that the game screen 80 displayed in this embodiment may be an image obtained by synthesizing the real space image and the virtual space image, for example, may be a synthesized image obtained by superposing the virtual space image on the real space image or may be a synthesized image obtained by alpha-blending the real space image with the virtual space image at a given ratio.

### (4-5. Virtual Viewpoint Control Unit)

The virtual viewpoint control unit 98 is implemented mainly by the control unit 14. The virtual viewpoint control unit 98 changes at least one of the position and the sight line direction of the virtual viewpoint (for example, virtual camera 72) in response to the user's operation. In this case, the virtual viewpoint control unit 98 changes at least one of the position and the sight line direction of the virtual camera 72 based on the position, the size, and the orientation of the detection subject (for example, marker 50) within the real space image.

The virtual viewpoint control unit 98 controls the virtual camera 72 so that a positional relationship between a reference position (for example, position of the marker 50) within the real space and the photographing range of the photographing unit 94 corresponds to a positional relationship between a reference position (for example, position of an origin of the game space 60) of the game space 60 and the visual field of the virtual camera 72.

In other words, the virtual viewpoint control unit 98 controls the virtual camera 72 so that a relationship between a coordinate system (hereinafter referred to as “real space coordinate system”) of the real space and a coordinate system (hereinafter referred to as “real viewpoint coordinate system”) of the photographing unit 94 corresponds to a relationship between a coordinate system (hereinafter referred to as “virtual space coordinate system”) of the game space 60 and a coordinate system (hereinafter referred to as “virtual viewpoint coordinate system”) of the virtual camera 72.

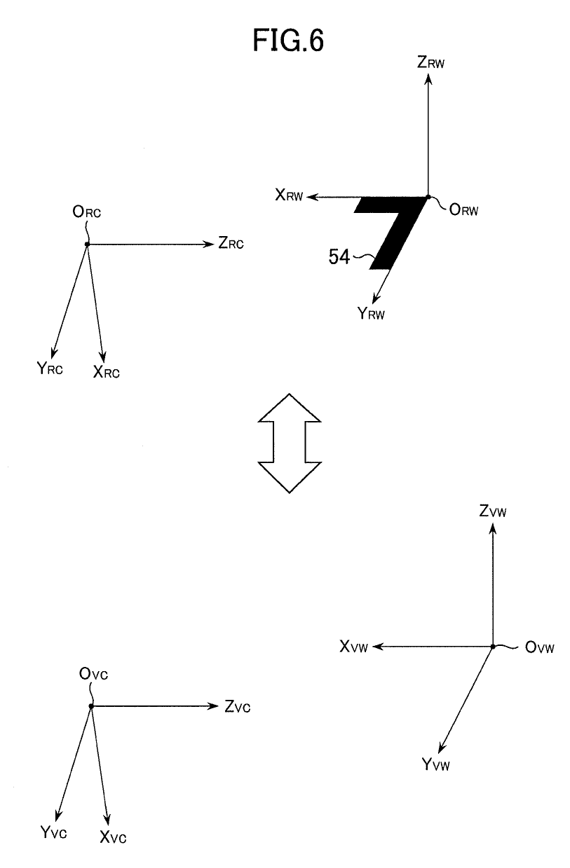

FIG. 6 is a diagram for illustrating a method of controlling the virtual camera 72 which is performed by the virtual viewpoint control unit 98. As illustrated in FIG. 6, for example, in the real space, the real space coordinate system (X_{RW}-Y_{RW}-Z_{RW} coordinate system) is set based on the pattern 54 drawn in the marker 50, and the real viewpoint coordinate system (X_{RC}-Y_{RC}-Z_{RC}) coordinate system) is set based on the position and the sight line direction of the photographing unit 94.

The real space coordinate system is a coordinate system for indicating the position of the object disposed in the real space, and is a coordinate system using the pattern 54 drawn in the marker 50 as a reference. On the other hand, the real viewpoint coordinate system is a coordinate system for indicating the positional relationship between the photographing unit 94 and the object disposed in the real space, and is a coordinate system using the photographing unit 94 as a reference.

In this case, an origin O_{RW} of the real space coordinate system is set to a predetermined position of the pattern 54 drawn in the marker 50. An X_{RW}-axis direction corresponds to a short-side direction of the “L-shaped” pattern 54, and a Y_{RW}-axis direction corresponds to a long-side direction of the “L-shaped” pattern 54. A Z_{RW}-axis direction is an outer-product direction between the X_{RW}-axis direction and the Y_{RW}-axis direction.

On the other hand, an origin O_{RC} of the real viewpoint coordinate system is set to the position of the photographing unit 94. For example, an X_{RC}-axis direction corresponds to a long-side direction of the real space image (in other words, horizontal direction when viewed from the photographing unit 94), and a Y_{RC}-axis direction corresponds to a short-side direction of the real space image (in other words, perpendicular direction when viewed from the photographing unit 94). Further, for example, a Z_{RC}-axis direction is set to the sight line direction of the photographing unit 94.

The real space coordinate system (X_{RW}-Y_{RW}-Z_{RW} coordinate system) can be converted into the real viewpoint coordinate system (X_{RC}-Y_{RC}-Z_{RC} coordinate system) by being rotated and translated. The virtual viewpoint control unit 98 calculates a coordinate conversion matrix used for conversion from the real space coordinate system into the real viewpoint coordinate system based on display information (position, size, and orientation) on the pattern 54 of the marker 50 within the real space image.

Specifically, first, the virtual viewpoint control unit 98 extracts the frame 52 of the marker 50 within the real space image based on known outline extraction processing. When the frame 52 of the marker 50 is extracted, the positions of four corners of the frame 52 within the real space image are identified, to thereby identify the position of the marker 50 that appears in the real space image.

Then, the virtual viewpoint control unit 98 performs pattern matching processing between the pattern 54 drawn within the extracted frame 52 and the image data on the pattern 54 stored in the augmented reality data, to thereby identify the type of the marker 50, the size of the marker 50 that appears in the real space image, and the orientation of the pattern 54.

Based on the position of the marker 50 within the real space image and a displacement amount between the size and the orientation of the marker 50 within the real space image and the size and the orientation of the marker 50 stored in the augmented reality data, rotation components and translation components used for the conversion from the real space coordinate system into the real viewpoint coordinate system are calculated, to thereby acquire the coordinate conversion matrix.

By converting the virtual space coordinate system (X_{VW}-Y_{VW}-Z_{VW} coordinate system) based on the coordinate conversion matrix, the virtual viewpoint coordinate system (X_{VC}-Y_{VC}-Z_{VC} coordinate system) is set.

The virtual space coordinate system is a coordinate system for indicating the position of each of the objects disposed in the game space 60, and an origin O_{VW} is set to a given position (for example, position on the field 62) within the game space 60. The virtual viewpoint coordinate system is a coordinate system for indicating the positional relationship between the virtual camera 72 and each of the objects. For example, the position of the virtual camera 72 is set as an origin O_{VC} of the virtual viewpoint coordinate system, and the sight line direction of the virtual camera 72 is set as a Z_{VC}-axis direction of the virtual viewpoint coordinate system. The virtual viewpoint coordinate system is defined by rotating and translating the virtual space coordinate system as indicated by the coordinate conversion matrix.

As described above, the virtual space image showing how the game space 60 is viewed from the virtual camera 72 whose position and sight line direction are determined is generated, and the game screen 80 is displayed by the display control unit 96. Note that a method of controlling the position of the virtual camera 72 by using the marker 50 is not limited to the above-mentioned example, and various known methods can be applied. In addition, the position of the virtual camera 72 may be controlled by, for example, simultaneously detecting a plurality of markers 50.

### (4-6. Current Value Guide Unit)

The current value guide unit 100 is implemented mainly by the control unit 14 and the display unit 22. The current value guide unit 100 shows the user a current value of one game parameter (for example, energy parameter). The current value guide unit 100 shows the value of the energy parameter to the user by displaying the current value gauge 84b indicating the current value of the energy parameter.

Further, when one game parameter (for example, energy parameter) is changed by the game parameter changing unit 104, the current value guide unit 100 expands and contracts the current value gauge 84b depending on the change. When the game parameter increases, the current value gauge 84b expands by a length corresponding to the increase amount, and when the game parameter decreases, the current value gauge 84b contracts by a length corresponding to the decrease amount.

Further, in this case, the current value guide unit 100 functions as means for displaying an image having substantially the same length as an expansion/contraction length of the current value gauge 84b which is used in the case where the operation subject makes an attack (for example, consumption amount image 84c having the same length as the expansion/contraction length) in such a position that an edge part of the image corresponds to an edge part of the current value gauge 84b. Note that the above-mentioned means may be implemented by the game execution unit 92 or the display control unit 96. Such a position that the edge part of the consumption amount image 84c corresponds to the edge part of the current value gauge 84b is defined by a relationship in which the positions in an expansion/contraction direction (in this embodiment, horizontal direction) of the current value gauge 84b substantially match each other in the edge part of the consumption amount image 84c and the edge part of the current value gauge 84b.

### (4-7. Action Control Unit)

The action control unit 102 is implemented mainly by the control unit 14. The action control unit 102 causes the operation subject (for example, tank 64) to perform an action in response to an operation performed by the user. In this case, a content of the user's operation is previously associated with the type of the action of the tank 64, and the tank 64 performs the action of the type associated with a content of the operation input by the user. For example, when the user performs the direction instruction operation, the tank 64 rotates or moves in the direction indicated by the direction instruction operation. Further, for example, when the user performs the attack instruction operation, the tank 64 launches a shell in a direction in which a sighting has been taken (for example, toward the front of the tank 64).

### (4-8. Game Parameter Changing Unit)

The game parameter changing unit 104 is implemented mainly by the control unit 14. The game parameter changing unit 104 changes one game parameter (for example, energy parameter) in at least two cases where the operation subject (for example, tank 64) moves, where the operation subject attacks the enemy 66, and where the operation subject receives damage due to the attack from the enemy 66. The phrase “changing the game parameter” refers to increasing or decreasing the value of the game parameter.

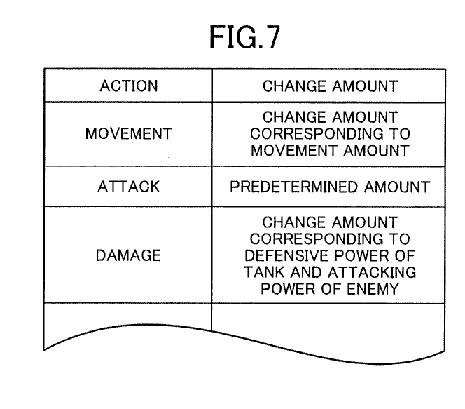

FIG. 7 is a diagram illustrating a change amount of an energy parameter which is obtained in the case where the tank 64 moves, the case where the tank 64 makes an attack, and the case where the tank 64 receives damage due to the attack from the enemy 66. As illustrated in FIG. 7, data indicating the change amount (increase amount or decrease amount) of the energy parameter obtained in each of the cases may be stored in the game data storage unit 90.

For example, the game parameter changing unit 104 changes the energy amount by an amount corresponding to the movement amount obtained in the case where the tank 64 moves. Further, for example, the game parameter changing unit 104 changes the energy amount by a predetermined amount or an amount defined based on a parameter indicating the ability (performance) specific to the tank 64 in the case where the tank 64 attacks the enemy 66. Further, for example, the game parameter changing unit 104 changes the energy amount by a predetermined amount or an amount defined based on a parameter indicating the ability (performance) specific to the tank 64 and a parameter indicating the ability of the enemy 66 in the case where the tank 64 receives damage due to the attack from the enemy 66.

### (4-9. Game Parameter Determination Unit)

The game parameter determination unit 106 is implemented mainly by the control unit 14. The game parameter determination unit 106 determines whether or not the value of one game parameter (for example, energy parameter) is within a predetermined range. As in this embodiment, in a case where the game parameter is decreased by the game parameter changing unit 104, it is determined that the game parameter is within the predetermined range in a case where the game parameter is equal to or smaller than a threshold value. On the other hand, in a case where the game parameter is increased by the game parameter changing unit 104, it is determined that the game parameter is within the predetermined range in a case where the game parameter is larger than the threshold value.

### (4-10. Action Inhibition Unit)

The action inhibition unit 108 is implemented mainly by the control unit 14. The action inhibition unit 108 inhibits the operation subject (for example, tank 64) from performing an action in a case where it is determined that the value of one game parameter (for example, energy parameter) is within the predetermined range. In this case, in a case where the energy parameter is equal to or smaller than the threshold value, the tank 64 is inhibited from performing an action.

The phrase “inhibiting the tank 64 from performing an action” refers to restricting the tank 64 from performing an action even if the user performs an operation, and has a meaning including, for example, causing the user's game to be over, bringing the tank 64 to an inoperative state, and reducing the remaining number of tanks 64. Note that in the case of reducing the remaining number of tanks 64, information indicating the remaining number is stored in the game data storage unit 90 and updated so as to correspond to the progress of the game. For example, when the remaining number becomes zero and when the energy parameter becomes zero, the game is over.

### 5. Processing Executed by the Game Device

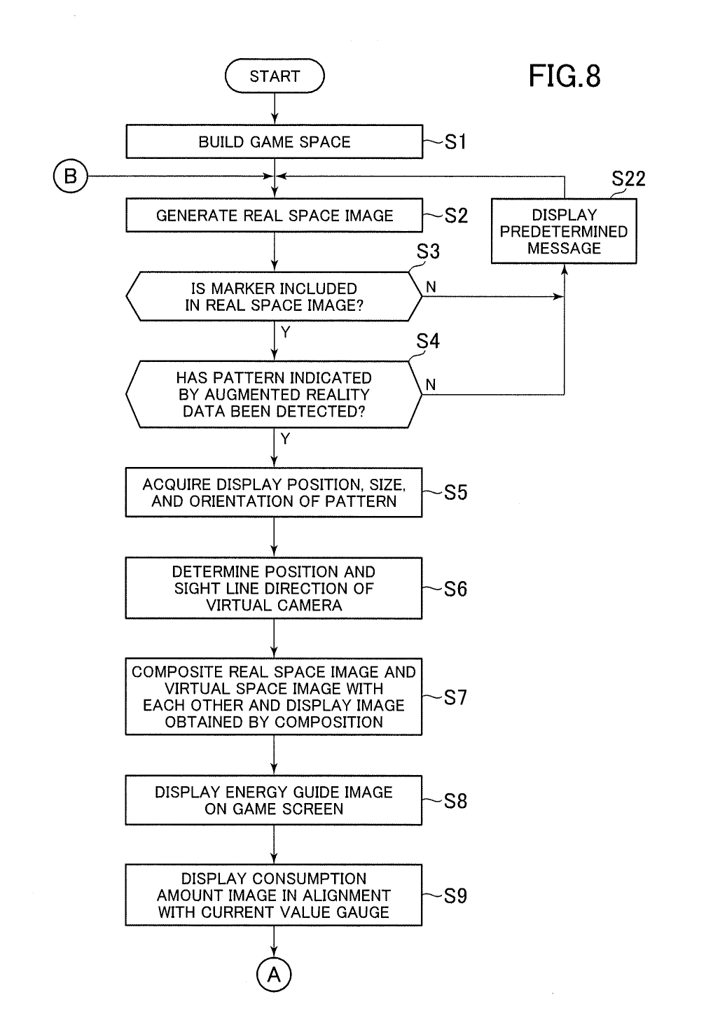

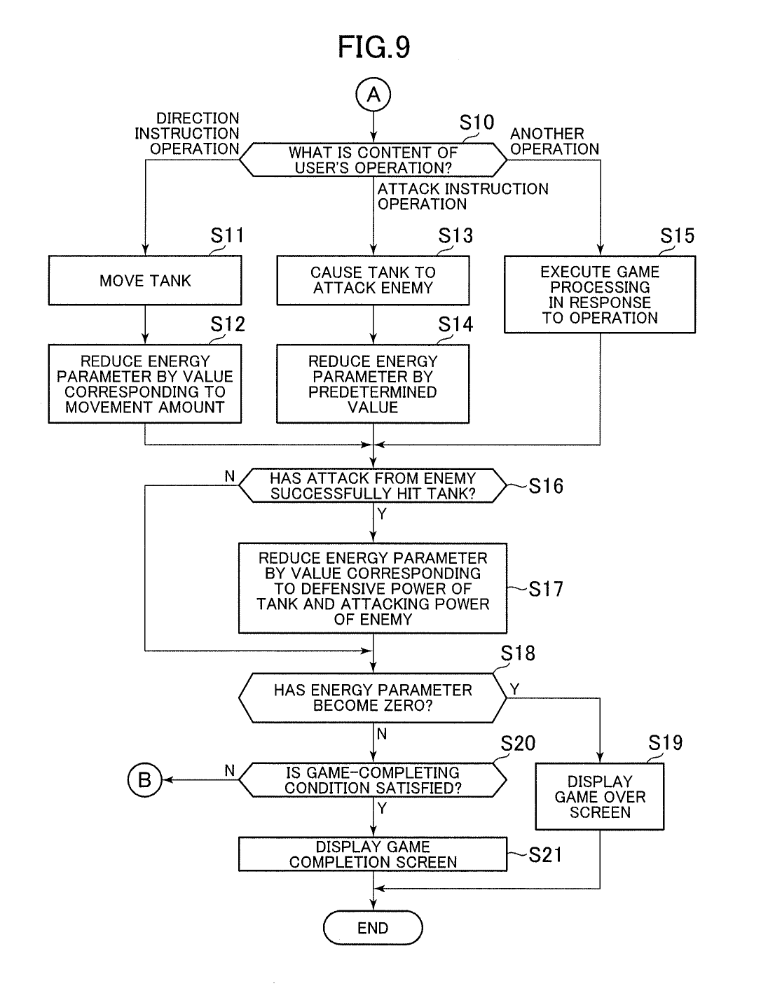

Next, description is given of processing executed by the game device 10. FIGS. 8 and 9 are flowcharts illustrating processing executed by the game device 10 which relates to the present invention. The control unit 14 executes the processing illustrated in FIGS. 8 and 9 in accordance with, for example, the program stored in the memory card 30. For example, when an instruction to start the game is input, the processing illustrated in FIGS. 8 and 9 is executed.

As illustrated in FIG. 8, first, the control unit 14 builds the game space 60 in the main memory 18 (S1). In Step S1, for example, each of objects within the game space 60 is disposed in an initial position defined in advance, and the energy parameter is set to an initial value. Further, in a stage of Step S1, the virtual camera 72 may be kept from being disposed in the game space 60.

The control unit 14 causes the camera 44 to photograph the real space to generate the real space image (S2). The camera 44 continuously photographs the real space to generate the real space image at predetermined time intervals. The image data on the real space image may be temporarily stored in the main memory 18.

The control unit 14 determines whether or not the marker 50 is included in the real space image (S3). In Step S3, with reference to the real space image generated in Step S2, it is determined whether or not the marker 50 is included, based on whether or not the frame 52 of the marker 50 has been detected. For example, while data indicating a pattern having a shape of the frame 52 is previously stored in the augmented reality data, the pattern is compared with the real space image, to thereby detect the frame 52.

When it is determined that the marker 50 is included (S3; Y), the control unit 14 determines whether or not the pattern 54 indicated by the augmented reality data has been detected by comparing the pattern 54 drawn within the frame 52 of the marker 50 with the pattern 54 stored in the augmented reality data (S4). In this embodiment, it is determined whether or not the “L-shaped” marker 50 has been detected.

When it is determined that the pattern 54 indicated by the augmented reality data has been detected (S4; Y), the control unit 14 acquires a display position, the size, and the orientation of the pattern 54 within the real space image (S5). In Step S5, for example, a display position of a reference point (for example, point at which the short side and the long side of the L shape cross each other), which is set in the pattern 54, is identified. Further, for example, information relating to the size of the pattern 54 is acquired based on an area of pixels that match the pattern 54 stored in the augmented reality data within the real space image. Further, for example, information relating to the orientation of the marker 50 is acquired based on a displacement amount between the pattern 54 of the marker 50 within the real space image and the pattern 54 stored in the augmented reality data.

The control unit 14 determines the position and the sight line direction of the virtual camera 72 based on the display position, the size, and the orientation of the pattern 54 acquired in Step S5 (S6). For example, the coordinate conversion matrix from the real space coordinate system into the real viewpoint coordinate system is calculated based on the position, the size, and the orientation of the marker 50. Then, the position of the origin O_{VC} of the virtual viewpoint coordinate system and the directions of the three axes are determined by applying the above-mentioned coordinate conversion matrix to the virtual space coordinate system. For example, the origin O_{VC} of the virtual viewpoint coordinate system is determined as the position of the virtual camera 72, and the Z_{VC}-axis direction is determined as the sight line direction of the virtual camera 72.

The control unit 14 synthesizes the real space image generated by the camera 44 and the virtual space image showing how the game space 60 is viewed from the virtual camera 72 whose position and sight line direction are determined in Step S6 and displays an image obtained by the synthesizing on the game screen 80 (S7).

The control unit 14 displays the energy guide image 84 indicating the current value of the energy parameter on the game screen 80 (S8). At the start of the game, the energy parameter is set to an initial value (for example, maximum value of the energy parameter), and the energy guide image 84 indicating the initial value is displayed.

The control unit 14 displays the consumption amount image 84c, which indicates the decrease amount of the energy parameter used in the case where the tank 64 makes an attack, in alignment with the current value gauge 84b (S9). In this embodiment, the current value gauge 84b contracts in a direction from a right edge part (first edge part) of the current value gauge 84b toward a left edge part (second edge part) thereof in the case where the tank 64 makes an attack, and hence, as illustrated in FIG. 4, the consumption amount image 84c is displayed so that a right edge position of the current value gauge 84b that has contracted in the case where the tank 64 makes an attack corresponds to a left edge position of the consumption amount image 84c, and so that the current right edge position of the current value gauge 84b corresponds to the right edge position of the consumption amount image 84c.

Referring next to FIG. 9, the control unit 14 acquires a signal from the operation key unit 32 to determine a content of the user's operation (S10). In a case where the user performs the direction instruction operation (Step S10; direction instruction operation), the control unit 14 moves the tank 64 in the direction indicated by the direction instruction operation (S11). The control unit 14 reduces the energy parameter of the tank 64 by a value corresponding to the movement amount of the tank 64 (S12). For example, as the movement amount of the tank 64 increases, the energy parameter decreases.

In a case where the user performs the attack instruction operation (Step S10; attack instruction operation), the control unit 14 causes the tank 64 to launch a shell to attack the enemy (S13), and reduces the energy parameter of the tank 64 by a predetermined value (S14). In Step S14, the object representing the shell is generated in the game space 60, and moves based on a movement algorithm defined in the game program. When the object representing the shell comes into contact with the enemy 66, a given damage can be caused to the enemy 66. Further, it is possible to defeat the enemy 66 when a parameter indicating the stamina of the enemy 66 is within a predetermined range (for example, equal to or smaller than the reference value).

When the user performs another operation (Step S10; another operation), the control unit 14 executes game processing in response to the operation (S15). For example, when an instruction operation to use an item in the game is performed, the energy parameter may be changed (recovered).

The control unit 14 determines whether or not the attack from the enemy 66 has successfully hit the tank 64 (S16). In Step S16, for example, it is determined whether or not the object representing the shell launched by the enemy 66 has come into contact with the tank 64. In other words, it is determined whether or not the tank 64 has received damage due to the attack from the enemy 66.

When it is determined that the attack from the enemy 66 has successfully hit the tank 64 (S16; Y), the control unit 14 reduces the energy parameter of the tank 64 by a value corresponding to the defensive power of the tank 64 and the attacking power of the enemy 66 (S17). In Step S17, for example, the energy parameter is changed by a value obtained by substituting the defensive power of the tank 64 and the attacking power of the enemy 66 into a given numerical expression.

The control unit 14 determines whether or not the energy parameter has become zero (S18). When it is determined that the energy parameter has become zero (S18; Y), the control unit 14 displays a game over screen (S19), which brings the processing to an end.

On the other hand, when it is not determined that the energy parameter has become zero (S18; N), the control unit 14 determines whether or not a given game-completing condition is satisfied (S20). The game-completing condition is a predefined condition for an occurrence of a game completion event and, for example, is a condition indicating whether or not all the enemies 66 have been defeated. In Step S20, for example, it is determined whether or not the game situation data satisfies the game-completing condition.

When it is determined that the given game-completing condition is satisfied (S20; Y), the control unit 14 displays a game completion screen (S21), which brings the processing to an end. When it is not determined that the given game-completing condition is satisfied (S20; N), the processing returns to Step S2.

Note that when it is not determined that the marker 50 is included (S3; N), or when it is not determined that a predetermined marker 50 has been detected (S4; N), the control unit 14 erases the virtual space image from the game screen 80, and displays a predetermined message such as “the marker cannot be detected” on the display unit (S22). In this case, the user changes the position and the orientation of the game device 10 so that the marker 50 is included in the photographing range of the camera 44 and so that the marker 50 is displayed in a position that enables detection thereof.

According to the game device 10 described above, the movement, the attack, and the damage of the tank 64 are managed by one energy parameter, and hence it is possible to provide the user with the game that is high in strategic property which is configured so that the tank 64 is caused to destroy enemy 66 without performing a wasteful action. Further, by displaying the consumption amount image 84c, it is possible to cause the user to easily grasp the change amount of the energy parameter used in the case where the tank 64 makes an attack.

### 6. Modified Examples

Note that the present invention is not limited to the embodiment described above. Changes can appropriately be made without departing from the gist of the present invention.

(1) For example, in such a game as in the embodiment, the virtual camera 72 does not follow the movement of the tank 64 but is controlled in response to the user's operation, and hence the tank 64 may disappear from the game screen 80 depending on the user's operation. In this case, the energy parameter of the tank 64 may be changed. For example, when the tank 64 disappears from the game screen 80, the energy parameter may be increased.

The game device 10 according to Modified Example (1) includes means for determining whether or not the operation subject (for example, tank 64) is being displayed on the display means (for example, display unit 22). The above-mentioned means is implemented by, for example, the game execution unit 92. For example, it is determined whether or not the tank 64 is included within the visual field of the virtual camera 72, or whether or not another object (such as, for example, an obstruction 68) exists between the tank 64 and the virtual camera 72. In at least one of a case where the tank 64 is included within the visual field of the virtual camera 72 and a case where another object does not exist between the tank 64 and the virtual camera 72, the tank 64 is displayed on the game screen 80.

The game device 10 according to Modified Example (1) includes means for changing the game parameter (for example, energy parameter) when it is determined that the operation subject (for example, tank 64) is not being displayed on the display means (for example, display unit 22). The above-mentioned means may be implemented by, for example, the game execution unit 92 or the game parameter changing unit 104.

In this case, when the tank 64 is not being displayed on the game screen 80, the energy parameter increases or decreases. For example, the energy parameter may increase or decrease by a value corresponding to a period during which the tank 64 is not being displayed on the game screen 80.

According to Modified Example (1), for example, in a case where a remaining amount of the energy parameter becomes smaller, when the user changes the photographing range of the camera 44 to keep the tank 64 from being displayed on the game screen 80, the energy parameter is increased to enable the tank 64 to move or make an attack again. In other words, in a case where the remaining amount of the energy parameter becomes smaller with a higher risk of the game being over, by keeping the tank 64 from being displayed on the game screen 80, it is possible to increase the energy parameter while making it hard for the user to operate the tank 64 and making it impossible to avoid the attack from the enemy 66.

On the other hand, in a case where the energy parameter is decreased when the tank 64 disappears from the game screen 80, the risk of the game being over becomes higher, which can give the game a tense atmosphere by utilizing such characteristics of the control of the virtual camera 72 as in the embodiment.

(2) Further, for example, in such a game as in the embodiment, even if the tank 64 is not being displayed on the game screen 80, the user can operate the tank 64, but the change amount of the energy parameter used in the case where the tank 64 is not being displayed on the game screen 80 may be caused to differ from the change amount of the energy parameter used in the case where the tank 64 is being displayed on the game screen 80.

The game parameter changing unit 104 according to Modified Example (2) includes means for increasing or decreasing the change amount of the game parameter (for example, energy parameter) in the case where the operation subject (for example, tank 64) is being displayed on the display means (for example, display unit 22) compared to the case where the operation subject is not being displayed on the display means.

For example, the game parameter changing unit 104 increases or decreases the change amount of the energy parameter used in the case where the tank 64 moves, the change amount of the energy parameter used in the case where the tank 64 makes an attack, and the change amount of the energy parameter used in the case where the tank 64 receives damage due to the attack from the enemy 66, in the case where the tank 64 is not being displayed on the game screen 80 compared to the case where the tank 64 is being displayed on the game screen 80.

The game is likely to be over when the change amount of the energy parameter is increased in the case where the tank 64 is not being displayed on the game screen 80 compared to the case where the tank 64 is being displayed on the game screen 80, and hence the tank 64 that is not being displayed on the game screen 80 is given a disadvantage compared to the tank 64 that is being displayed on the game screen 80.

On the other hand, the game is less likely to be over when the change amount of the energy parameter is decreased in the case where the tank 64 is not being displayed on the game screen 80 compared to the case where the tank 64 is being displayed on the game screen 80, and hence the tank 64 that is not being displayed on the game screen 80 is given an advantage compared to the tank 64 that is being displayed on the game screen 80.

Note that the tank 64 may be brought to a state of not being displayed on the game screen 80 in the case where the virtual camera 72 moves and in the case where the tank 64 moves. Between those cases, the processing according to Modified Example (1) and the processing according to Modified Example (2) may be appropriately used.

In this case, in the case where the tank 64 is not being displayed on the game screen 80, the game execution unit 92 determines which of the virtual camera 72 and the tank 64 has been moved to stop displaying the tank 64 on the game screen 80. The above-mentioned determination is performed based on a change in the position of the virtual camera 72 and a change in the position of the tank 64 in the case where the tank 64 is not being displayed on the game screen 80. For example, when it is determined that the tank 64 is not being displayed on the game screen 80, the change in the position of the virtual camera 72 and the change in the position of the tank 64 during a predetermined period are acquired with reference to the game situation data. When the change in the position of the virtual camera 72 is equal to or larger than the reference amount, it is determined that the virtual camera 72 has been moved to stop displaying the tank 64 on the game screen 80, and when the change in the position of the tank 64 is equal to or larger than the reference amount, it is determined that the tank 64 has been moved to stop displaying the tank 64 on the game screen 80.

For example, when it is determined that the virtual camera 72 has been moved to stop displaying the tank 64 on the game screen 80, the energy parameter may be changed by executing the processing according to Modified Example (1), and when it is determined that the tank 64 has been moved to stop displaying the tank 64 on the game screen 80, the change amount of the energy parameter may be caused to differ by executing the processing according to Modified Example (2).

Further, on the contrary to the above description, when it is determined that the virtual camera 72 has been moved to stop displaying the tank 64 on the game screen 80, the change amount of the energy parameter may be caused to differ by executing the processing according to Modified Example (2), and when it is determined that the tank 64 has been moved to stop displaying the tank 64 on the game screen 80, the energy parameter may be changed by executing the processing according to Modified Example (1).

(3) Further, for example, the change amount of the energy parameter may be caused to differ depending on a positional relationship between the tank 64 and the virtual camera 72 or a positional relationship between the tank 64 and a reference point (for example, origin O_{VW}) within the game space 60. For example, the change amount of the energy parameter may be caused to become larger as a distance between the tank 64 and the virtual camera 72 or a distance between the tank 64 and the origin O_{VW} becomes shorter.

The game data storage unit 90 according to Modified Example (3) stores: a condition (hereinafter referred to as “positional relationship condition”) relating to the positional relationship between the position of the operation subject (for example, tank 64) or the reference point (for example, origin O_{VW} of the game space 60) which is set in the virtual space and the position of the virtual viewpoint (for example, virtual camera 72); and change amount information related to the change amount of the game parameter (for example, energy parameter), in association with each other.

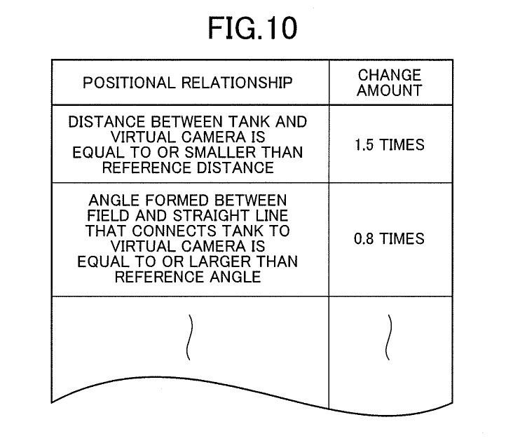

FIG. 10 is a diagram illustrating association between the positional relationship condition and the change amount information. Stored as the positional relationship condition is one of: a condition related to the distance between the tank 64 or the origin O_{VW} and the virtual camera 72; and a condition related to a direction that connects the tank 64 or the origin O_{VW} to the virtual camera 72 (for example, angle formed between the field 62 and a straight line that connects the tank 64 or the origin O_{VW} to the virtual camera 72).

Stored as the change amount information is information indicating the change amount of the energy parameter which is changed in the case where the tank 64 moves, the case where the tank 64 makes an attack, and the case where the tank 64 receives damage due to the attack from the enemy 66. For example, the change amount of the energy parameter becomes larger or smaller as the distance between the tank 64 and the virtual camera 72 or the origin O_{VW} becomes smaller.

The game device 10 according to Modified Example (3) includes means for determining whether or not the positional relationship condition is satisfied by the current positional relationship between the position of the operation subject (for example, tank 64) or the reference point (for example, origin O_{VW} of the game space 60) and the position of the virtual viewpoint (for example, virtual camera 72). The above-mentioned means is implemented by the game execution unit 92 or the like. It is determined whether or not the positional relationship condition is satisfied by comparing the game situation data with the positional relationship condition.

The game parameter changing unit 104 according to Modified Example (3) changes the game parameter (for example, energy parameter) based on the change amount information associated with the positional relationship condition satisfied by the current positional relationship between the position of the operation subject (for example, tank 64) or the reference point (for example, origin O_{VW} of the game space 60) and the position of the virtual viewpoint (for example, virtual camera 72). In other words, the change amount of the energy parameter which is used in the case where the tank 64 moves, the case where the tank 64 makes an attack, and the case where the tank 64 receives damage is determined based on the change amount information associated with the positional relationship condition determined to be satisfied.

For example, by causing the change amount of the energy parameter to become larger as the distance between the tank 64 or the origin O_{VW} and the virtual camera 72 becomes smaller, it is possible to increase the consumption amount of the energy parameter in a situation in which it is easy to take a sighting at each of the objects such as the tank 64 being displayed relatively largely on the game screen 80. On the other hand, by causing the change amount of the energy parameter to become smaller as the distance between the tank 64 or the origin O_{VW} and the virtual camera 72 becomes smaller, it is possible to reduce the consumption amount of the energy parameter in a case where a range displayed on the game screen 80 is relatively narrow.

Note that the above description is directed to the case where the change amount of the energy parameter differs depending on the distance between the tank 64 or the origin O_{VW} and the virtual camera 72, but the change amount of the energy parameter may be increased or decreased depending on the direction that connects the tank 64 or the origin O_{VW} to the virtual camera 72. For example, the change amount of the energy parameter may be caused to become larger or smaller as the angle formed between the field 62 and the straight line that connects the tank 64 or the origin O_{VW} to the virtual camera 72 becomes smaller.

(4) Further, for example, the energy parameter may be changed depending on the positional relationship between the camera 44 and the marker 50 within the real space. In the case where the marker 50 disappears from the photographing range of the camera 44 or in a case where the marker 50 is photographed from a lateral direction, the pattern 54 drawn in the marker 50 fails to be detected, which keeps the game that utilizes the augmented reality from being provided. In such a case, the energy parameter may be reduced to show the user that the marker 50 is not being detected.

The game device 10 according to Modified Example (4) includes means for determining, based on the real space image, whether or not the current positional relationship between the detection subject (for example, marker 50) and photographing means (for example, camera 44) is a given positional relationship. The above-mentioned means is implemented by the game execution unit 92. The given positional relationship has a meaning including a positional relationship in which a distance between the marker 50 and the camera 44 is within a predetermined range (for example, equal to or larger than a reference distance), a positional relationship in which the marker 50 falls (or does not fall) within the photographing range of the camera 44, and a positional relationship in which an angle formed between the marker 50 and a straight line that connects the marker 50 to the camera 44 is within a predetermined range.

In this case, it is determined whether or not the above-mentioned current positional relationship is a positional relationship in which the marker 50 is likely to be detected. The positional relationship where the marker 50 is likely to be detected is a predefined positional relationship that enables the marker 50 to be detected from the real space image and, for example, is a positional relationship in which the distance between the marker 50 and the camera 44 is within a predetermined range (equal to or larger than a first reference distance and equal to or smaller than a second reference distance larger than the first reference distance) or a positional relationship in which the angle formed between the sight line direction of the camera 44 and the marker 50 is within a predetermined range (equal to or larger than a first reference angle and equal to or smaller than a second reference angle larger than the first reference angle).

Further, the game device 10 includes means for changing the game parameter (for example, energy parameter) when it is determined that the current positional relationship between the detection subject (for example, marker 50) and the photographing means (for example, camera 44) is the given positional relationship. The above-mentioned means is implemented by the game execution unit 92 or the game parameter changing unit 104. For example, the energy parameter is decreased in a case of a positional relationship in which the marker 50 is less likely to be detected.

According to Modified Example (4), the energy parameter can be changed depending on the positional relationship between the marker 50 and the camera 44. For example, the game becomes disadvantageous for the user if the energy parameter is decreased when the above-mentioned current positional relationship is the positional relationship in which the marker 50 is less likely to be detected, and hence it is possible to lead the user to the positional relationship in which the marker 50 is likely to be detected.

(5) Further, for example, the change amount of the energy parameter may be caused to differ depending on the positional relationship between the marker 50 and the camera 44.

The game data storage unit 90 according to Modified Example (5) stores the condition relating to the positional relationship between the detection subject (for example, marker 50) and the photographing means (for example, camera 44) and the change amount information relating to the change amount of the game parameter (for example, energy parameter), in association with each other. The associated data has the same data structure as in FIG. 10. Stored as the condition relating to the positional relationship between the marker 50 and the camera 44 is a condition relating to the distance between the marker 50 and the virtual camera 72 or a condition relating to the angle formed between the marker 50 and the sight line direction of the virtual camera 72.

The game device 10 according to Modified Example (5) includes means for determining, based on the real space image, whether or not the above-mentioned condition is satisfied by the current positional relationship between the detection subject (for example, marker 50) and the photographing means (for example, camera 44). The above-mentioned means is implemented by, for example, the game execution unit 92. For example, the current positional relationship between the marker 50 and the camera 44 is acquired based on the position, the size, and the orientation of the marker 50 included in the real space image. The positional relationship is compared with the above-mentioned condition.

The game parameter changing unit 104 according to Modified Example (5) changes one game parameter (for example, energy parameter) based on the change amount information associated with the above-mentioned condition satisfied by the current positional relationship between the detection subject and the photographing means. In other words, the change amount of the energy parameter which is used in the case where the tank 64 moves, the case where the tank 64 makes an attack, and the case where the tank 64 receives damage is determined based on the above-mentioned change amount information.

According to Modified Example (5), for example, it is possible to increase or decrease the change amount of the energy parameter and to give the user an advantage or a disadvantage in a case where the camera 44 is in the positional relationship in which the marker 50 is less likely to be detected or a positional relationship in which the marker 50 is not detected compared to a case where the camera 44 is in the positional relationship in which the marker 50 is likely to be detected.

Note that with regard to not the one energy parameter as in the embodiment but another game parameter, the game parameter may be changed or the change amount of the game parameter may be caused to differ as in Modified Examples (1) to (5). For example, the technology according to Modified Example (1) and Modified Example (2) may be applied to a game configured so that a hit point that changes only in the case where the tank 64 receives the damage exists, and the hit point may be changed in the case where the tank 64 is not being displayed on the screen or the change amount of the hit point which is used in the case of receiving damage may be caused to differ. In the same manner, the technology according to Modified Example (3) may be applied to the above-mentioned game to cause the change amount of the hit point which is used in the case of receiving damage to differ depending on the positional relationship between the tank 64 and the virtual camera 72, or the technology according to Modified Example (4) and Modified Example (5) may be applied to the above-mentioned game to change the hit point or cause the change amount of the hit point which is used in the case of receiving damage to differ, depending on the positional relationship between the marker 50 and the camera 44.

(6) Further, for example, the description of the embodiment is directed to the case where the energy parameter is recovered when the user uses the predetermined item or the tank 64 stands by without moving, but another method may be used to change the energy parameter. For example, characteristics of the augmented reality may be utilized to change the energy parameter depending on the change in the position of the virtual camera 72. Information indicating the change in the position of the virtual camera 72 is stored in the game data storage unit 90 or the like in time series each time the virtual viewpoint control unit 98 determines the position of the virtual camera 72.

In this case, the condition relating to the change in at least one of the position and the sight line direction of the virtual camera 72 and the change amount of the energy parameter may be stored in the game data storage unit 90 in association with each other. The condition relating to the change in at least one of the position and the sight line direction of the virtual camera 72 has a meaning including a condition relating to the change amount in the position of the virtual camera 72, a condition relating to a direction of the change in the position of the virtual camera 72, or a condition relating to a trajectory of the change in the position of the virtual camera 72.

When the user changes the photographing range of the camera 44, the game execution unit 92 may determine whether or not the above-mentioned condition is satisfied by the change in at least one of the position and the sight line direction of the virtual camera 72, and may change the energy parameter based on the change amount associated with the condition determined to be satisfied. For example, the energy parameter may be recovered in a case where the virtual camera 72 moves by a distance equal to or larger than a predetermined distance, a case where the virtual camera 72 moves in a predetermined direction, or a case where the virtual camera 72 follows a predetermined trajectory.

(7) Further, for example, the description of the embodiment is directed to the case where the game is completed when all the enemies 66 have been destroyed, but the game may be completed when the energy parameter is within a reference range (for example, equal to or larger than the reference value) after a predetermined time has elapsed since the start of the game. Alternatively, for example, in a case of a game played by a plurality of users, the tank 64 operated by each of the plurality of users may be disposed on the field, and the user maintaining the largest energy parameter after a predetermined time has elapsed may win a victory.

(8) Further, for example, in a case where a plurality of tanks 64 that can be used by the user are provided, the change amount of the energy parameter may be caused to differ depending on the tank 64 operated by the user. For example, a first tank 64 may consume less energy in the movement and more energy in the attack than a second tank 64. In this case, information for identifying the tank 64 operated by the user and information indicating the change amount of the energy parameter may be stored in association with each other.

(9) Further, for example, the embodiment is described by taking the example of the game parameter that decreases in the case where the tank 64 makes an attack or another such case, but a game parameter (for example, parameter indicating an attrition rate) that increases in the case where the tank 64 makes an attack or another such case may be used. The game parameter increases when the tank 64 moves or makes an attack, and hence the current value gauge 84b expands so as to correspond to the increase.

For example, when the current value gauge 84b expands in a direction from the left edge part (first edge part) of the current value gauge 84b toward the right edge part (second edge part) thereof in the case where the tank 64 makes an attack, the consumption amount image 84c is displayed so that the current right edge position of the current value gauge 84b corresponds to the left edge position of the consumption amount image 84c and that the right edge position of the current value gauge 84b that has expanded in the case where the tank 64 makes an attack corresponds to the right edge position of the consumption amount image 84c.

(10) Further, for example, the description of the embodiment is directed to the case where the tank 64 moves on a horizontal plane, but the range within which the operation subject of the user moves is not limited to the example of the embodiment. For example, the operation subject may be an object such as a ball or a bird, and may move vertically in the virtual three-dimensional space in response to the user's operation.

(11) Further, for example, the method of providing the user with the augmented reality is described by taking the example of the method that uses the marker 50, but the method of providing the augmented reality is not limited to the above-mentioned example. In addition, for example, it is possible to use a method of disposing an object that emits visible light within the real space and controlling the virtual viewpoint based on the position of the object within the real space image, a markerless method of extracting a feature point from an object included in the real space image without disposing the marker 50 within the real space, and other such methods. Further, the position of the virtual camera 72 may be controlled based on information received from the sensor unit 42 (for example, information relating to the posture of the game device 10 obtained from the gyro sensor).

(12) Further, for example, the present invention can be applied to a game device for executing a game other than the game utilizing augmented reality. For example, the game may be configured so that the virtual camera 72 is controlled in response to an operation performed through the operation key unit 32. In addition, the operation subject of the user is not limited to a tank, and a character may be disposed in the virtual space as the operation subject. In this case, by using the same method as in the embodiment and Modified Examples, one game parameter indicating the current state of the character may be changed in the case where the character moves, the case where the character attacks the enemy, and the case where the character receives damage due to the attack from the enemy.

While there have been described what are at present considered to be certain embodiments of the invention, it will be understood that various modifications may be made thereto, and it is intended that the appended claims cover all such modifications as are within the true spirit and scope of the invention.

What is claimed is:

1. A game device for executing a game configured so that an operation subject of a user moves within a virtual space to attack an enemy, the game device comprising:
means for acquiring one game parameter indicating a current state of the operation subject from means for storing the one game parameter;
current value guide means for showing the user a current value of the one game parameter;
action control means for causing the operation subject to perform an action in response to an operation performed by the user;
game parameter changing means for changing the one game parameter in a case where the operation subject moves, a case where the operation subject attacks the enemy, and a case where the operation subject receives damage due to an attack from the enemy;
determination means for determining whether or not the current value of the one game parameter is within a predetermined range; and
inhibition means for inhibiting the operation subject from performing an action in a case where it is determined that the current value of the one game parameter is within the predetermined range.

2. The game device according to claim 1, further comprising:
means for causing display means to display a virtual space image showing how the virtual space is viewed from a virtual viewpoint;
means for changing at least one of a position and a sight line direction of the virtual viewpoint in response to the operation performed by the user;
means for determining whether or not the operation subject is being displayed on the display means; and
means for changing the one game parameter in a case where it is determined that the operation subject is not being displayed on the display means.

3. The game device according to claim 1, further comprising:
means for causing display means to display a virtual space image showing how the virtual space is viewed from a virtual viewpoint;
means for changing at least one of a position and a sight line direction of the virtual viewpoint in response to the operation performed by the user; and
means for determining whether or not the operation subject is being displayed on the display means,
wherein the game parameter changing means comprises means for one of increasing and decreasing a change amount of the one game parameter in a case where the operation subject is being displayed on the display means compared to a case where the operation subject is not being displayed on the display means.

4. The game device according to claim 1, further comprising:
means for causing display means to display a virtual space image showing how the virtual space is viewed from a virtual viewpoint;
means for changing at least one of a position and a sight line direction of the virtual viewpoint in response to the operation performed by the user;
means for acquiring change amount information relating to a change amount of the one game parameter from means for storing a condition and the change amount information in association with each other, the condition relating to a positional relationship between the position of the virtual viewpoint and one of a position of the operation subject and a reference point which is set in the virtual space; and
means for determining whether or not the condition is satisfied by a current positional relationship between the position of the virtual viewpoint and the one of the position of the operation subject and the reference point,
wherein the game parameter changing means changes the one game parameter based on the change amount information associated with the condition satisfied by the current positional relationship between the position of the virtual viewpoint and the one of the position of the operation subject and the reference point.

5. The game device according to claim 1, further comprising:
photographing means for photographing a real space in which a detection subject is disposed, which has a photographing range that changes in response to the operation performed by the user;
means for causing display means to display an image obtained by synthesizing a real space image showing the real space and a virtual space image showing how the virtual space is viewed from a virtual viewpoint;
means for changing at least one of a position and a sight line direction of the virtual viewpoint based on a position, a size, and an orientation of the detection subject within the real space image;
means for determining, based on the real space image, whether or not a current positional relationship between the detection subject and the photographing means comprises a given positional relationship; and
means for changing the one game parameter in a case where it is determined that the current positional relationship between the detection subject and the photographing means comprises the given positional relationship.

6. The game device according to claim 1, further comprising:
photographing means for photographing a real space in which a detection subject is disposed, which has a photographing range that changes in response to the operation performed by the user;
means for causing display means to display an image obtained by synthesizing a real space image showing the real space and a virtual space image showing how the virtual space is viewed from a virtual viewpoint;
means for changing at least one of a position and a sight line direction of the virtual viewpoint based on a position, a size, and an orientation of the detection subject within the real space image;
means for acquiring change amount information relating to a change amount of the one game parameter from means for storing a condition and the change amount information in association with each other, the condition relating to a positional relationship between the detection subject and the photographing means; and
means for determining, based on the real space image, whether or not the condition is satisfied by a current positional relationship between the detection subject and the photographing means,
wherein the game parameter changing means changes the one game parameter based on the change amount information associated with the condition satisfied by the current positional relationship between the detection subject and the photographing means.

7. The game device according to claim 1, wherein:
the current value guide means comprises:
means for showing the user the current value of the one game parameter by causing display means to display a current value gauge indicating the current value of the one game parameter; and
means for expanding and contracting, in a case where the one game parameter is changed by the game parameter changing means, the current value gauge depending on the change; and
the game device further comprises means for displaying an image having substantially the same length as an expansion/contraction length of the current value gauge which is used in the case where the operation subject makes an attack in such a position that an edge part of the image corresponds to an edge part of the current value gauge.

8. A method of controlling a game device for executing a game configured so that an operation subject of a user moves within a virtual space to attack an enemy, the method comprising:
a step of acquiring one game parameter indicating a current state of the operation subject from means for storing the one game parameter;
a current value guide step of showing the user a current value of the one game parameter;
an action control step of causing the operation subject to perform an action in response to an operation performed by the user;
a game parameter changing step of changing the one game parameter in a case where the operation subject moves, a case where the operation subject attacks the enemy, and a case where the operation subject receives damage due to an attack from the enemy;
a determination step of determining whether or not the current value of the one game parameter is within a predetermined range; and
an inhibition step of inhibiting the operation subject from performing an action in a case where it is determined that the current value of the one game parameter is within the predetermined range.

9. A non-transitory computer readable information storage medium having recorded thereon a program for causing a computer to function as a game device for executing a game configured so that an operation subject of a user moves within a virtual space to attack an enemy, the program causing the computer to function as:
means for acquiring one game parameter indicating a current state of the operation subject from means for storing the one game parameter;
current value guide means for showing the user a current value of the one game parameter;
action control means for causing the operation subject to perform an action in response to an operation performed by the user;
game parameter changing means for changing the one game parameter in a case where the operation subject moves, a case where the operation subject attacks the enemy, and a case where the operation subject receives damage due to an attack from the enemy;
determination means for determining whether or not the current value of the one game parameter is within a predetermined range; and
inhibition means for inhibiting the operation subject from performing an action in a case where it is determined that the current value of the one game parameter is within the predetermined range.
